(19) United States
(12) Patent Application Publication
(10) Pub. No.: US 2005/0286740 A1
(43) Pub. Date: Dec. 29, 2005

(54) Vehicle with image data signal source identification

(76) Inventor: Marc-Andre Sigle, Alzenau (DE)

Correspondence Address: MCGLEW & TUTTLE, PC, P.O. BOX 9227, SCARBOROUGH STATION, SCARBOROUGH, NY, 10510-9227, US

(21) Appl. No.: 11/157,458

(22) Filed: Jun. 21, 2005

(30) Foreign Application Priority Data
Jun. 24, 2004 (DE) 10 2004 030 657.5

(51) Int. Cl. G06K 9/00

(52) U.S. Cl. 382/104; 382/103

(57) ABSTRACT

A vehicle (01) includes at least one image display unit (02) and at least one image data signal source (04, 05, 06, 07, 08) which are connected to one another via at least one transmission channel (10). Each image data signal source (04, 05, 06, 07, 08) has at least one signal generator (09), whereby the signal generator (09) generates a control signal, which can be transmitted over the transmission channel (10), and whereby the control signal can be received and evaluated in an evaluation unit (03).

### CROSS REFERENCE TO RELATED APPLICATIONS

This application claims the benefit of priority under 35 U.S.C. § 119 of German Application DE 10 2004 030 657.5 filed Jun. 24, 2004, the entire contents of which are incorporated herein by reference.

### FIELD OF THE INVENTION

The invention relates to a vehicle comprising a video system consisting of at least one image display unit and at least one image data signal source.

### BACKGROUND OF THE INVENTION

Video systems in generic vehicles often consist of an image display unit and at least one image data signal source. This image data signal source may, for example, be in the form of a monitoring camera for the area behind the vehicle during the reversing operation and/or in the form of a navigation system.

The image data signals of all image data signal sources may each be displayed individually or in a combination on the at least one image display unit. To this effect it may be necessary to make a selection from the bulk of existing image data signals, which selection is to be displayed on the image display unit. This selection is dependent upon the particular situation in which the vehicle finds itself. If, for example, the reversing operation is initiated by inserting the reverse gear, it will be necessary to select at least the image data signal from the reversing camera.

With this state of the art it is disadvantageous that the video system does not have a control capability which would permit it to check that the selected image data signal is indeed the expected image data signal. This means that the display of safety-relevant image data signals and the presence of a transmission interruption of safety-relevant image data signals cannot be guaranteed.

Furthermore, it is not possible, with a video system comprising several image data signal sources, to avoid the display of an undesirable image data signal during a safety-relevant situation, in particular to avoid the display of image information other than that from the reversing camera during a reversing operation. Specifically, there may be an attempt to add a further image data signal source to the vehicle and connect it with the video system of the vehicle, or to effect a change in an existing image data signal source and obtain a display of the image data signals of the additional or changed image data signal source on the image display unit.

### SUMMARY OF THE INVENTION

It is therefore the object of the present invention to provide a vehicle comprising a new video system.

In the vehicle according to the invention each image data signal source has at least one signal generator. The signal generator generates a control signal which can be transmitted via a transmission channel. Furthermore, the vehicle according to the invention is equipped with an evaluation unit. The control signal can be received and evaluated in the evaluation unit.

This configuration offers the possibility of coupling the image data signals together with the control signal generated by the respective signal generator into the transmission channel at the place where they originate. Uncoupling of the signals from the transmission channel is effected in an environment of the image display unit which also includes the evaluation unit.

Thus the information included in the control signal, in particular information on the type of image data signal source and/or the name of an image data signal source, is available at the position of the image output unit and enables the image data signal to be identified by means of the control signal. Being able to perform this identification ensures the display of safety-relevant data, in particular of image data of the reversing camera during the reversing operation. Furthermore an interruption of safety-relevant data streams may be reliably detected in this way.

The type and positioning of the image display unit of the video system may be chosen at random in principle. Because of its small dimensions a flat screen is particularly suitable for use as the image display unit. Also a monitor, a visual display device or a projection device may be chosen as the image display unit. As regards the positioning of the image display unit, it is particularly advantageous if it is positioned within or near the field of view of the driver.

In particular in the case, where the various image data signal sources present are similar in type, such as a reversing camera and at least one further camera for monitoring another area, the additional optical display, on the image display unit, of the information contained in the control signal offers a further advantage. The driver is thus able to immediately recognize the origin of the image data displayed on the image display unit by means of the control signal information. The type and number of image data signal sources of the video system are, in principle, of no importance. In one particular embodiment, however, at least one video camera is present. This video camera can take pictures of an area which from the driver's position, is viewable at least incompletely, and may thus be used, in particular, as a reversing camera.

Furthermore it is possible to observe the area of the blind angle by means of the video camera. Further embodiments of the image data signal source are, for example, navigation systems, driver assist systems, computers, play back devices, in particular DVD play back devices, and television sets. It would also be feasible to provide a connection for external video sources.

The image data signals and control signals must travel from their respective place of origin to the evaluation unit and the image display unit. This requires a transmission channel. In principle, the form of the transmission channel is of no importance. Especially suitable is a transmission channel for signal transmission in a vehicle, which is in the form of a contact-entailing connection, in particular an electric conductor. This offers the advantage of being able to reuse existing electrical leads in cases where an old vehicle undergoes a retrofit, thus obviating the need for installing a new transmission channel. Hence a contactlessly transmitting transmission channel, for example a wireless radio transmission channel, would be suitable.

It is of no importance, in principle, whether transmission via the transmission channel is analogue or digital, and whether each image data signal source has its own transmission channel, or whether all image data signals and control signals are transmittable via a single transmission channel.

Optionally it is also possible to transmit the image data signal undlor the control signal in encoded form. This has the advantage that it would be much more difficult to functionally change the video system of the vehicle because in order to render the video system functionally operable, the code for the encoded transmission must be known. It is essential for the function of the proposed vehicle that the control signal generated by the signal generator can be unequivocally associated with the image data signal of an image data signal source. In order to meet this requirement, an especially suitable arrangement would be one where a signal generator is respectively arranged in the immediate vicinity of each image data signal source. Thus one control signal communicates with one image data signal respectively.

It is of no importance, in principle, whether in the case, where several image data signal sources are present, that each image data signal source has a signal generator. However, it should be ensured that at least one control signal corresponds with the image data of one safety-relevant image data signal source. In order to facilitate a compact design and to counteract contamination of the signal generator where this is arranged externally to the vehicle interior, the signal generator may be integrated with the associated image data signal source.

It is possible, by means of the evaluation unit, to check for the presence of a control signal, in particular of an expected control signal, at the evaluation unit. To this effect the evaluation unit receives information on the presence of a safety-relevant situation, for example of the reversing operation, for example from the central control of the vehicle and compares this information with the received control signal. The result of the comparison is passed on to the image display unit in the form of a result signal.

The display on the image display unit is dependent upon this result signal. For example, if the image data signal current of the reversing camera is interrupted during a reversing operation, a corresponding result signal can be passed on to the image display unit and an error message displayed on it. Furthermore the correct display of an expected image data signal can be checked by means of this result signal. In a further embodiment the evaluation unit can receive all image data signals and control signals and, after comparing the control signal with the situation-dependent information, filter out the at least one corresponding image data signal and pass it onto the image display unit. The evaluation unit, in all embodiments, can be arranged spatially separate from the image display unit or be integrated with the image display unit. The integrated arrangement offers a more compact design and shorter transmission distances between the evaluation unit and the image display unit.

The transmission standard for transmitting the image data signals and the control signals over the transmission channel is of no importance in principle. However, the FBAS transmission standard or any other standard similar to this one has proven to be especially advantageous. Specifically, this transmission standard needs only one transmission channel for all colour components. Furthermore, it is possible using this transmission standard, to additionally transmit a control signal over the same transmission channel.

In order to organize the transmission of the image data signals and control signals over the transmission channel, a signal connecting element may be arranged between the image data signal source, the signal generator and the transmission channel. This signal connecting element organizes the transmission of data according to a certain pattern. The signal connecting element may be in any shape or form in principle. It is, however, especially advantageous if the signal connecting element takes the form of a known integrated circuit, in particular a video encoder. The special advantage of this is that commercially available components can be used in this arrangement.

On the output side of the transmission channel a signal separating element can be arranged. This signal separating element should be in a form matching the signal connecting element on the input side of the transmission channel. The signal separating element can reorganize the data coming from the transmission channel such that the control and image data signals are available again as separate signals. Again, the signal separating element may be in any shape or form in principle. Advantageously in this case as well, the signal separating element may take the form of an integrated circuit compatible with the signal connecting element, a video decoder, in particular, is especially suitable.

Transmission of the image data signal and the control signal as such via the transmission channel is of no importance in principle. It is particularly advantageous, however, if image data signals and control signals can be transmitted in alternate sections via the transmission channel. For this nested transmission in terms of time ensures the unequivocal relationship between image data signals and control signals. One form of this alternating transmission of data is the transmission of the control signal within the vertical blank interval.

This may be implemented using a known transmission standard for the transmission of information during the vertical blank interval such as close captioning, wide screen signaling (WSS), copy generation management system (CGMS) and video programming system (VPS). The Teletext transmission standard is a further transmission standard which utilizes the vertical blank interval. It is especially advantageous if the control signal is transmitted in the form of the Teletext transmission standard or in a form similar to this transmission standard via the transmission channel. To this effect the data transmitted in the various Teletext formats (US Teletext, World Standard Teletext (WST), Euro WST, PAL WST, NTSC WST, CCST, Videotext, Telidon, NABTS) may be used or amended for identification of the corresponding image data signal source. Particularly advantageous with such an embodiment is the possibility of being able to utilize existing hardware components.

One schematic illustration of the embodiment of the invention is shown in the drawings and shall now be explained by way of example with reference to the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the preferred embodiment of the invention is illustrated.

### BRIEF DESCRIPTION OF THE DRAWINGS

In the drawings:

FIG. 1 is a schematic view of the functional principle of the vehicle according to the invention; and

FIG. 2 is a schematized data flow diagram of the data flows between individual components of the vehicle according to the invention.

### DESCRIPTION OF THE PREFERRED EMBODIMENT

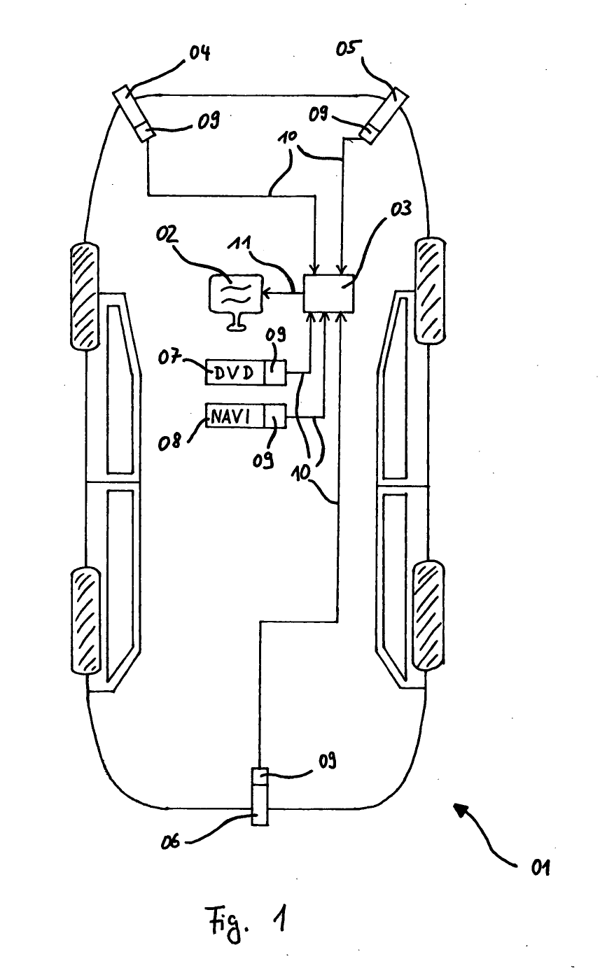

Referring to the drawings in particular, the vehicle 01 shown in FIG. 1 comprises an image data unit 02, an evaluation unit 03 and several image data signal sources. The image data signal sources in this embodiment take the form of video cameras for the front and side areas 04, 05 and of a reversing camera 06. Further, the vehicle has a DVD play back device 07 and a navigation device 08. All image data signal sources 04, 05, 06, 07, 08 are equipped with a signal generator 09 for generating the control signal. The image data signals and control signals are transmitted each via a transmission channel to the evaluation unit 03. The result of the evaluation in the evaluation unit 03 is transmitted to the image display unit in the form a result signal 11.

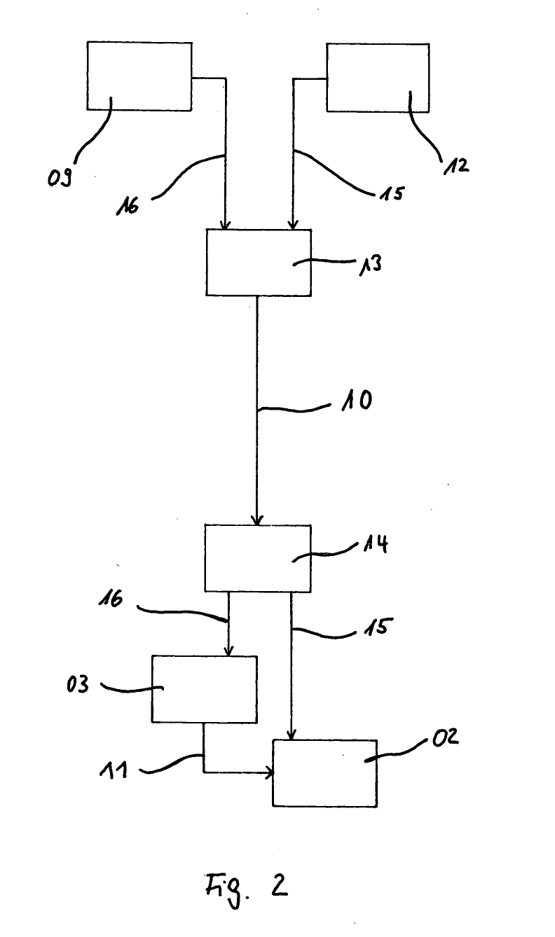

FIG. 2 is a schematic view of the data flows between individual components of the vehicle. The vehicle comprises any given image data signal source 12, a signal generator 09, a signal connecting element 13, a signal separating element 14, an evaluation unit 03 and an image display unit 02. The image data signal 15 generated by the image data signal source 12 and the control signal 16 generated by the signal generator 09 are prepared for transmission over the transmission channel 10 by means of the signal connecting element 13 and made available again by means of the signal separating element 14. In this embodiment the control signal 16 is passed on to the evaluation unit 03. The result of the evaluation in the evaluation unit 03 is transmitted to the image display unit 02 in the form of a result signal 11. The image data signal 15 made available again by the signal separating element 14 is passed on directly to the image display unit 02 in this embodiment.

While a specific embodiment of the invention has been shown and described in detail to illustrate the application of the principles of the invention, it will be understood that the invention may be embodied otherwise without departing from such principles.

1. A vehicle comprising:
an image display unit;
a transmission channel;
an image data signal source, the image display unit being connected with the image data signal source over said channel;
a signal generator associated with the image data signal source, the signal generator generating a control signal transmittable over the transmission channel; and
an evaluation unit for receiving and evaluating the control signal.

2. A vehicle according to claim 1, wherein the image display unit comprises one of a monitor and a visual display with a flat screen.

3. A vehicle according to claim 1, wherein the information contained in the control signal is one of automatically and selectively displayed information on the image display unit.

4. A vehicle according to claim 1, wherein the image data signal source consists of at least one video camera.

5. A vehicle according to claim 4, wherein the at least one video camera is provided as a reversing camera that takes pictures from an area which from the driver's position, is viewable at least incompletely.

6. A vehicle according to claim 1, wherein the image data signal source is in the form of a play back device including one or more of a DVD play back device and a digital storage play back device.

7. A vehicle according to claim 1, wherein the image data signal source is in the form of a navigation system.

8. A vehicle according to claim 1, wherein the image data signal source is in the form of a television receiver.

9. A vehicle according to claim 1, wherein an image data signal and/or a control signal can be transmitted contact-entailingly, or contact based, over the transmission channel through electric current or signaling.

10. A vehicle according to claim 1, wherein an image data signal and/or a control signal can be transmitted contactlessly over the transmission channel through electro-magnetic waves.

11. A vehicle according to claim 1, wherein an image data signal and/or a control signal is transmitted in encoded form over the transmission channel.

12. A vehicle according to claim 1, wherein the control signal generated by the signal generator is unequivocally associated with an image data signal of an image data signal source.

13. A vehicle according to claim 1, wherein the signal generator is integrated with the associated image data signal source.

14. A vehicle according to claim 1, wherein the presence of a control signal including an expected control signal, at the evaluation unit can be checked by means of the evaluation unit.

15. A vehicle according to claim 1, wherein the result of the evaluation of the evaluation unit is transmitted to the image display unit in the form of a result signal, whereby the signal display of the image display unit can be influenced by means of the result signal.

16. A vehicle according to claim 1 wherein the evaluation unit is integrated with the image display unit.

17. A vehicle according to claim 1, wherein an image data signal and/or control signal can be transmitted over the transmission channel in the form of the FBAS transmission standard or a form similar to that of this transmission standard.

18. A vehicle according to claim 1, wherein a signal connecting element is arranged between the image data signal source and the signal generator and the transmission channel.

19. A vehicle according to claim 18, wherein the signal connecting element is in the form of an integrated circuit including a video encoder.

20. A vehicle according to claim 1, wherein a signal separating element is arranged between the image display unit and the transmission channel.

21. A vehicle according to claim 20, wherein the signal separating element is in the form of an integrated circuit, in particular in the form of a video decoder.

22. A vehicle according to claim 1, wherein image data signals and control signals can be transmitted in alternate sections over the transmission channel.

23. A vehicle according to claim 22, wherein the control signal can be transmitted within the vertical blank interval.

24. A vehicle according to claim 1, wherein the control signal is transmitted over the transmission channel in a form of the Teletext transmission standard or a video text format that is similar to the Teletext transmission standard.
